(19) United States
(12) Patent Application Publication
(10) Pub. No.: US 2006/0069888 A1
(43) Pub. Date: Mar. 30, 2006

(54) Method, system and program for managing asynchronous cache scans

(75) Inventor: Richard K. Martinez, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines (IBM) Corporation, Armonk, NY (US)

(21) Appl. No.: 10/955,602

(22) Filed: Sep. 29, 2004

(51) Int. Cl. G06F 12/00; G06F 12/16

(52) U.S. Cl. 711/162; 711/113

(57) ABSTRACT

A method, apparatus, and article of manufacture containing instructions for the management of data in a point-in-time logical copy relationship between a source and multiple target storage devices. The method consists of establishing first and second point-in-time logical copy relationships between a source storage device and at least two target storage devices concerning an extent of data. Upon establishment of the point-in-time copy relationships, a first cache scan request is received relating to the first point-in-time logical copy relationship to remove a first extent of data from cache; a similar cache scan request is received related to the second point-in-time logical copy relationship. The first cache scan request is processed, and the successful completion of both the first cache scan request and the second cache scan request is returned to the storage controller upon the processing of only the first cache scan request.

### TECHNICAL FIELD

The present invention relates to a method, system and program for managing asynchronous cache scans, and in particular to a method, system and program for managing cache scans associated with a point-in-time copy relationship between a source and multiple targets.

### BACKGROUND ART

In many computing systems, data on one storage device such as a direct access storage device (DASD) may be copied to the same or other storage devices so that access to data volumes can be provided from multiple devices. One method of copying data to multiple devices is a point-in-time copy. A point-in-time copy involves physically copying all of the data from source volumes to target volumes so that the target volumes have a copy of the data as of a select point in time. Typically, a point-in-time copy is made with a multi-step process. Initially, a logical copy of the data is made followed by copying actual data over when necessary, in effect deferring the physical copying. Logical copy operations are performed to minimize the time during which the target and source volumes are inaccessible. One such logical copy operation is known as FlashCopy® (FlashCopy® is a registered trademark of international Business Machines Corporation or “IBM®”). FlashCopy® involves establishing a logical point-in-time relationship between source and target volumes on the same or different devices. Once the logical relationship is established, host computers may then have immediate access to the data on the source or target volumes. The actual data is typically copied later as part of a background operation.

Recent improvements to point-in-time copy systems such as FlashCopy® support multiple relationship point-in-time copying. Thus, a single point-in-time copy source may participate in multiple relationships with multiple targets so that multiple copies of the same data can be made for testing, backup, disaster recovery, and other applications.

The creation of a logical copy is often referred to as the establish phase or “establishment.” During the establish phase of a point-in-time copy relationship, a metadata structure is created for this relationship. The metadata is used to map source and target volumes as they were at the time when the logical copy was requested, as well as to manage subsequent reads and updates to the source and target volumes. Typically, the establish process takes a minimal amount of time. As soon as the logical relationship is established, user programs running on a host have access to both the source and target copies of the data.

Although the establish process takes considerably less time than the subsequent physical copying of data, in critical operating environments even the short interruption of host input/output (I/O) which can accompany the establishment of a logical point-in-time copy between a source and a target may be unacceptable. This problem can be exacerbated when one source is being copied to multiple targets. In basic point-in-time-copy prior art, part of the establishment of the logical point-in-time relationship required that all tracks in a source cache that are included in the establish command be destaged to the physical source volume. Similarly, all tracks in the target cache included in the logical establish operation were typically discarded. These destage and discard operations during the establishment phase of the logical copy relationship could take several seconds, during which host I/O requests to the tracks involved in the copy relationship were suspended. Further details of basic point-in-time copy operations are described in commonly assigned U.S. Pat. No. 6,611,901, entitled METHOD, SYSTEM AND PROGRAM FOR MAINTAINING ELECTRONIC DATA AS OF A POINT-IN-TIME, which patent is incorporated herein by reference in its entirety.

The delay inherent in destage and discard operations is addressed in commonly assigned and copending U.S. application Ser. No. 10/464,029, filed on Jun. 17, 2003, entitled METHOD, SYSTEM AND PROGRAM FOR REMOVING DATA IN CACHE SUBJECT TO A RELATIONSHIP, which application is incorporated herein by reference in its entirety. The copending application teaches a method of completing the establishment of a logical relationship without completing the destaging of source tracks in cache and the discarding of target tracks. In certain implementations, the destage and discard operations are scheduled as part of an asynchronous scan operation that occurs following the initial establishment of the logical copy relationship. Running the scans asynchronously allows the establishment of numerous relationships at a faster rate because the completion of any particular establishment is not delayed until the cache scans complete.

Although the scheduling of asynchronous scans is effective in minimizing the time affected volumes are unavailable for host I/O, the I/O requests can be impacted, in some cases significantly, when relationships between a single source and multiple targets are established at once. For example, known point-in-time copy systems presently support a single device as a source device for up to twelve targets. As discussed above, asynchronous cache scans must run on the source device to commit data out of cache. When a client establishes twelve logical point-in-time copy relationships at once, each one of the cache scans must compete for customer data tracks. Host I/O can be impacted if the host competes for access to the same tracks that the scans are accessing. In some instances, if the host is engaging in sequential access, host access will follow the last of the twelve scans.

Thus there remains a need for a method, system and program to manage asynchronous cache scans where a single source is established in a point-in-time copy arrangement with multiple targets such that the establishment of a point-in-time copy relationship minimizes the impact on host I/O operations.

### SUMMARY OF THE INVENTION

The need in the art is met by a method, apparatus, and article of manufacture containing instructions for the management of data in a point-in-time logical copy relationship between a source and multiple target storage devices. The method consists of establishing first and second point-in-time logical copy relationships between a source storage device and at least two target storage devices concerning an extent of data. Upon establishment of the point-in-time copy relationships, a first cache scan request is received relating to the first point-in-time logical copy relationship to remove a first extent of data from cache. A similar cache scan request is received relating to the second point-in-time logical copy relationship. The first cache scan request is processed, and the successful completion of both the first cache scan request and the second cache scan request is returned to the storage controller upon the processing of only the first cache scan request.

The second extent of data may be identical to or contained within the first extent of data. Preferably, the processing of the first cache scan request will not occur until both the first and second point-in-time logical copy relationships are established. The method is further applicable to point-in-time copy relationships between a source and multiple targets. Subsequent cache scan requests relating to the same extent of data, or an extent contained within the first extent of data, may be maintained in a wait queue.

### BRIEF DESCRIPTION OF THE DRAWINGS

FIG. 1 schematically illustrates a computing environment in which aspects of the invention are implemented;

FIG. 2 illustrates a data structure used to maintain a logical point-in-time copy relationship in accordance with implementations of the invention;

FIG. 3 illustrates a data structure used to maintain a logical point-in-time copy relationship in accordance with implementations of the invention;

FIG. 4 illustrates the operations performed in accordance with an embodiment of the invention when an asynchronous cache scan is invoked; and

FIG. 5 illustrates the operations performed in accordance with an embodiment of the invention when an asynchronous cache scan completes.

### DETAILED DESCRIPTION OF THE PREFERRED EMBODIMENT

In the following description, reference is made to the accompanying drawings which form a part hereof and which illustrate an embodiment of the present invention. It is understood that other embodiments may be utilized and structural and operational changes may be made without departing from the scope of the present invention.

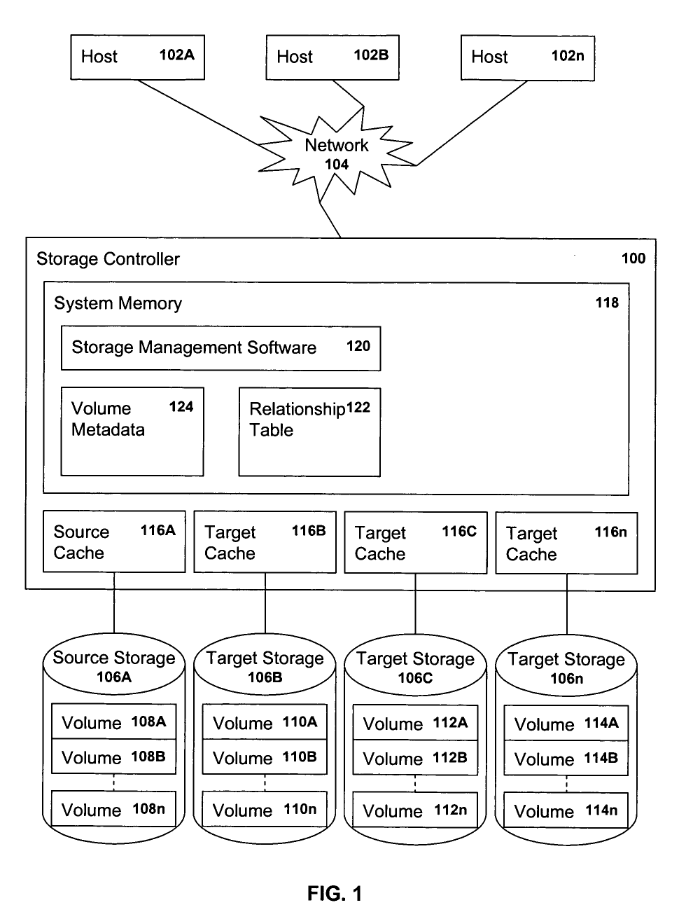

FIG. 1 illustrates a computing system in which aspects of the invention are implemented. A storage controller 100 receives Input/Output (I/O) requests from host systems 102A, 102B . . . 102n over a network 104. The I/O requests are directed toward storage devices 106A, 106B, 106C . . . 106n configured to have volumes (e.g., logical unit numbers, logical devices, etc.) 108A, 108B . . . 108n; 110A, 110B . . . 110n; 112A, 112B . . . 112n; and 114A, 114B . . . 114n, respectively, where n may be different integer values or the same value. All target volumes will be referred to collectively below as “target volumes 110A-114n.” The storage controller 100 further includes a source cache 116A to store I/O data for tracks in the source storage 106A and target caches 116B, 116C . . . 116n to store I/O data for tracks in the target storage 106B, 106C . . . 106n. The source 116A and target caches 116B, 116C . . . 116n may comprise separate memory devices or different sections of a same memory device. The caches 116A, 116B, 116C . . . 116n are used to buffer read and write data being transmitted between the hosts 102A, 102B . . . 102n and the storages 106A and 106B, 106C . . . 106n. Further, although caches 116A, 116B, 116C . . . 116n are and are referred to as source or target caches, respectively, for holding source or target tracks in a point-in-time copy relationship, the caches 116A, 116B, 116C . . . 116n may store at the same time source or target tracks in different point-in-time copy relationships.

The storage controller 100 also includes a system memory 118 which may be implemented in volatile and/or nonvolatile devices. Storage management software 120 executes in the system memory 118 to manage the copying of data between the different storage devices 106A, 106B, 106C . . . 106n, such as management of the type of logical copying that occurs during a point-in-time copy operation. The storage management software 120 may perform operations in addition to the copying operations described herein. The system memory 118 may be in a separate memory device from caches 116A, 116B, 116C . . . 116n or a part thereof. The storage management software 120 maintains a relationship table 122 in the system memory 118, providing information on established point-in-time copies of tracks in source target volumes 108A, 108B . . . 108n and specified tracks in storage target volumes 110A-114n. The storage controller 100 further maintains volume metadata 124 providing information on the target volumes 110A-114n.

The storage controller 100 would further include a processor complex (not shown) and may comprise any storage controller or server known in the art such as the IBM® Enterprise Storage Server®, 3990® Storage Controller, etc. The hosts 102A, 102B . . . 102n may comprise any computing device known in the art such as a server, mainframe, workstation, personal computer, handheld computer, laptop, telephony device, network appliance, etc. The storage controller 100 and host system(s) 102A, 102B . . . 102n communicate via a network 104 which may comprise a storage area network (SAN), local area network (LAN), intranet, the internet, wide area network (WAN), etc. The storage systems may comprise an array of storage devices such as a just a bunch of disks (JBOD), redundant array of independent disks (RAID) array, virtualization device, etc.

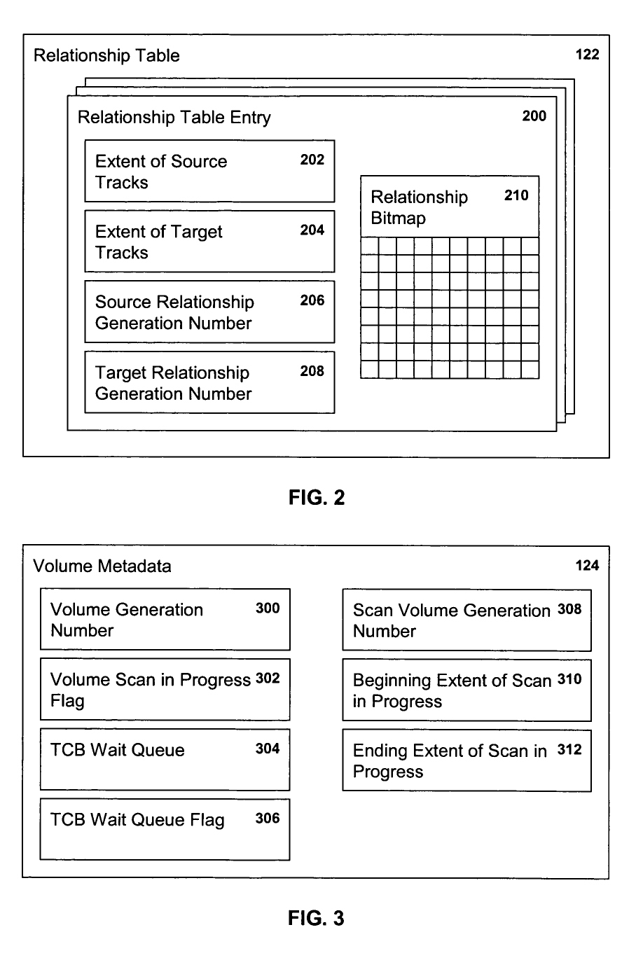

FIG. 2 illustrates data structures that may be included in the relationship table 122 generated by the storage management software 120 when establishing a point-in-time copy operation. The relationship table 122 is comprised of a plurality of relationship table entries 200 (only one is shown in detail) for each established relationship between a source volume, for example 108A, and a target volume, for example 110A. Each relationship table entry 200 includes an extent of source tracks 202. An extent is a contiguous set of allocated tracks. It consists of a beginning track, an end track, and all tracks in between. Extent size can range from a single track to an entire volume. The extent of source tracks 202 entry indicates those source tracks in the source storage 106A involved in the point-in-time relationship and the corresponding extent of target tracks 204 in the target storage, for example 106B, involved in the relationship, wherein an nth track in the extent of source tracks 202 corresponds to the nth track in the extent of target tracks 204. A source relationship generation number 206 and target relationship generation number 208 indicate a time, or timestamp, for the source relationship including the tracks indicated by the extent of source tracks 202 when the point-in-time copy relationship was established. The source relationship generation number 206 and target relationship generation number 208 may differ if the source volume generation number and target volume generation number differ.

Each relationship table entry 200 further includes a relationship bitmap 210. Each bit in the relationship bitmap 210 indicates whether a track in the relationship is located in the source storage 106A or target storage, for example 106B. For instance, if a bit is “on” (or “off”), then the data for the track corresponding to such bit is located in the source storage 106A. In implementations where source tracks are copied to target tracks as part of a background operation after the point-in-time copy is established, the bitmap entries would be updated to indicate that a source track in the point-in-time copy relationship has been copied over to the corresponding target track. In alternative implementations, the information described as implemented in the relationship bitmap 210 may be implemented in any data structure known in the art such as a hash table, etc.

In certain prior art embodiments, the establishment of a logical point-in-time relationship required that all tracks in a source cache 116A be destaged to a physical source volume 108A, 108B . . . 108n, and all tracks in a target cache 116B, 116C . . . 116n be discarded during the establishment of the logical copy relationship. The destage and discard operations during the establishment of the logical copy relationship could take several seconds, during which I/O requests to the tracks involved in the copy relationship would be suspended. This burden on host I/O access can be reduced by an implementation of asynchronous scan management (ASM). ASM provides for destage and discard cache scans after the establishment of a point-in-time logical relationship. An embodiment of ASM is disclosed in commonly assigned and copending U.S. application Ser. No. 10/464,029, filed on Jun. 17, 2003, entitled METHOD, SYSTEM AND PROGRAM FOR REMOVING DATA IN A CACHE SUBJECT TO A RELATIONSHIP, which application is incorporated herein by reference in its entirety.

Typically, ASM uses a simple first in, first out (FIFO) doubly linked list to queue any pending asynchronous cache scans. ASM will retrieve the next logical copy relationship from a queue, and then call a cache scan subcomponent to run the scan. Preferably, ASM is structured such that no cache scans will run until a batch of established commands have completed.

Certain implementations of point-in-time copy functions such as IBM® FlashCopy®, Version 2, support the contemporaneous point-in-time copy from a single source to multiple targets. In such an implementation, multiple establish commands will be issued for a single source track extent contemporaneously. If ASM as described above is implemented on such a system, no cache scans will run until the entire batch of establish commands has completed. Once the multiple establish commands have completed, ASM will have queued multiple cache scans to commit data from the same source device. Typically, the ASM would then start draining the queue in a FIFO manner with multiple scans made for the same source extent for the same purpose of committing the same data from cache. The delay inherent in such redundancy can be minimized by running the first cache scan and returning to ASM that each of the multiple cache scans for the same source extent have successfully completed.

An embodiment of the present invention may be implemented by use of information which can be stored in the volume metadata 124 of the system memory 118. FIG. 3 illustrates information within the volume metadata 124 that would be maintained for each source volume 108A, 108B . . . 108n and target volume 110A-114n configured in storage 106A, 106B, 106C . . . 106n. The volume metadata 124 may include a volume generation number 300 for the particular volume that is the subject of a point-in-time copy relationship. The volume generation number 300 is incremented each time a relationship table entry 200 is made in which the given volume is a target or source. Thus, the volume generation number 300 is a clock and indicates a timestamp following the most recently created relationship generation number for the volume. Each source volume 108A, 108B . . . 108n and target volume 110A-114n would have volume metadata 124 providing a volume generation number 300 for that volume involved in a relationship as a source or target.

The volume metadata 124 also includes a volume scan in progress flag 302 which can be set to indicate that ASM is in the process of completing a scan of the volume. In addition, the volume metadata 124 may include a TCB wait queue 304. A TCB is an operating system control block used to manage the status and execution of a program and its subprograms. With respect to the present invention, a TCB is a dedicated scan task control block which represents a process that is used to initiate scan operations to destage and discard all source and target tracks, respectively, for a relationship. Where a point-in-time copy operation has been called between a source and multiple targets, the TCB wait queue 304 can be maintained to queue each TCB for execution. If a TCB is queued in the TCB wait queue 304, the TCB wait queue flag 306 will be set.

The volume metadata 124 may also include a scan volume generation number 308 which can receive the current volume generation number 300. Also shown on FIG. 3 and maintained in the volume metadata are the beginning extent of a scan in progress 310 and the ending extent of a scan in progress 312.

As described generally above, it is unnecessary to run multiple cache scans if the scans are of the same extent and for the same purpose of committing data from cache. In this case, system efficiency can be increased by running the first scan and returning to the ASM that each of the multiple scans has completed. Thus, the workload on cache data tracks is minimized leading to quicker data access for host I/O operations.

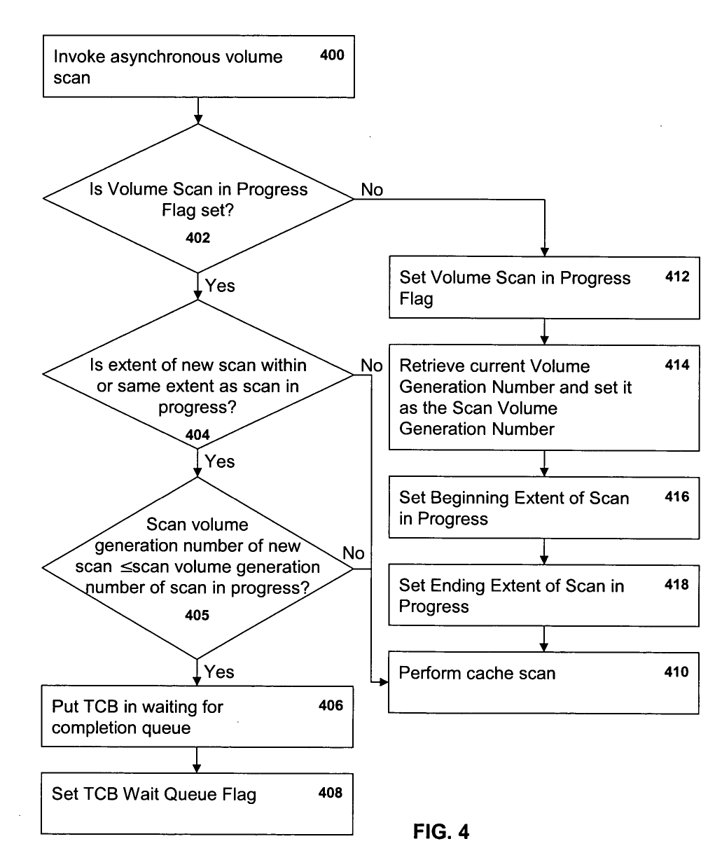

FIG. 4 illustrates the operations performed by the storage management software 120 when an asynchronous scan is invoked. It should be noted that under the preferred implementation of ASM, multiple establish commands will have been processed establishing a logical point-in-time copy relationship between a source device and multiple target devices. Upon the invocation of an asynchronous volume scan by ASM (step 400), a determination is made whether a volume scan in progress flag 302 is set (step 402). If a volume scan in progress flag 302 has been set, a determination is made whether the extent of the newly requested scan is within or the same as the extent of the scan that is in progress (step 404). This determination is made by examining the beginning extent of scan in progress 310 and ending extent of scan in progress 312 structures in the volume metadata 124. In addition, a determination is made if the scanned volume generation number 308 of the newly requested scan is less than or equal to the scan volume generation number 308 of the scan in progress (step 405). If this condition is met and the extent of the new scan is within or the same as the extent of the scan that is in progress, the TCB for the newly requested scan is placed in the TCB wait queue 304 (step 406). In addition, the TCB wait queue flag 306 is set (step 408).

At this point, the newly invoked scan (step 400) having been determined to be of the same extent as a scan in progress (steps 402, 404) will not invoke a duplicative cache scan.

If it is determined in step 404 that the extent of the newly invoked scan is not within or the same as the extent of a scan in progress, or if it is determined in step 405 that the scan volume generation number is greater than the scan volume generation number of the scan in progress, a cache scan is performed in due course according to FIFO or another management scheme implemented by ASM (step 410).

If the volume scan in progress flag 302 is not set (step 402), the new invocation of an asynchronous volume scan (step 400) will cause the volume scan in progress flag 302 to be set (step 412). Also, the current volume generation number 300 will be retrieved and set as the scan volume generation number 308 (step 414). In addition, the beginning extent of the scan in progress 310 and ending extent of the scan in progress 312 will be set (steps 416, 418) to correspond to the extents of the newly invoked volume scan. ASM will then perform the cache scan (step 410).

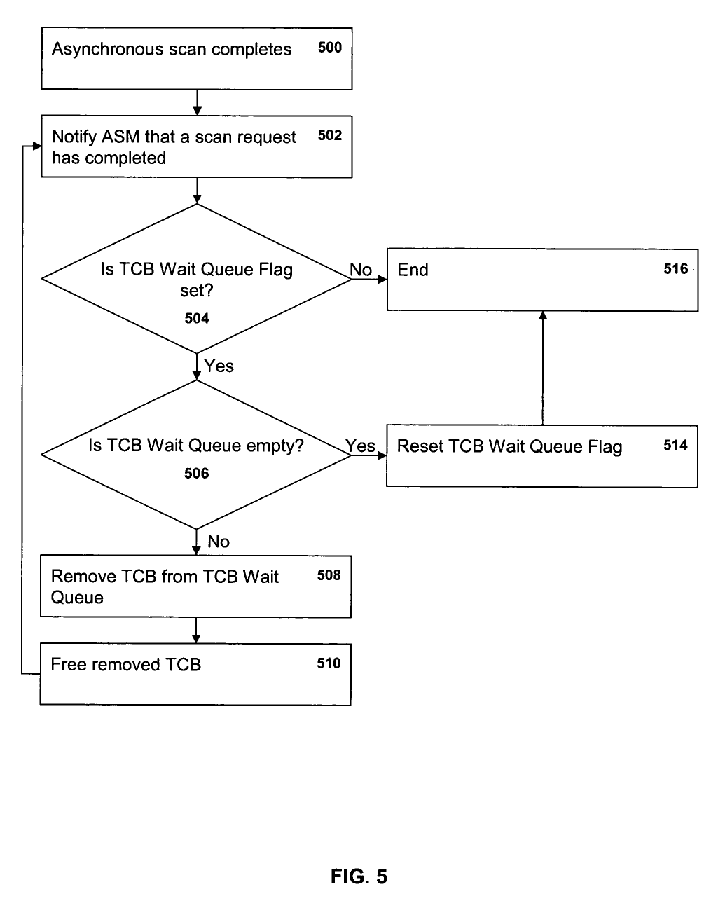

FIG. 5 illustrates the operations performed upon the completion of an asynchronous cache scan which will lead to increased efficiency. Upon completion of an asynchronous scan (step 500), notification is made to ASM that a scan request has been successfully completed (step 502). Next, a determination is made whether the TCB wait queue flag 306 had been set (step 504). If it is determined that the TCB wait queue flag 306 had been set, a determination is made whether the TCB wait queue 304 is empty (step 506). If the TCB wait queue 304 is not empty, the first queued TCB is removed from the queue (step 508). In addition, the removed TCB will be processed to complete operations defined in its function stack, and then may be freed (step 510). The ASM will be informed that the asynchronous scan request represented by the TCB in the queue has completed (step 502). Steps 504-512 will repeat while the TCB wait queue flag 306 is set and while there are TCBs in the TCB wait queue 304. Thus, the ASM will be notified that an asynchronous scan has been successfully completed for each TCB in the TCB wait queue 304 based upon the completion of the single initial asynchronous scan.

If a determination is made in step 506 that the TCB wait queue 304 is empty, the TCB wait queue flag 306 may be reset (step 514), and the process will end (step 516). Similarly, if it is determined in step 504 that the TCB wait queue flag 306 is not set after an asynchronous scan completes, no scans for the same extent are queued and a single notification will be made to the ASM that the single scan request has successfully completed (step 502).

The illustrated logic of FIGS. 4-5 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The described techniques for managing asynchronous cache scans may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., magnetic storage medium such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media such as network transmission line, wireless transmission media, signals propagating through space, radio waves, infrared signals, etc. Of course, those skilled in the art will recognize that many modifications may be made to this configuration without departing from the scope of the implementations and that the article of manufacture may comprise any information bearing medium known in the art.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

1. A method of managing data comprising:
establishing a first point-in-time logical copy relationship between a source and a first target relating to a first extent of data;
establishing a second point-in-time logical copy relationship between the source and a second target relating to a second extent of data;
receiving a first cache scan request related to the first point-in-time logical copy relationship to remove the first extent of data from a cache;
receiving a second cache scan request related to the second point-in-time logical copy relationship to remove the second extent of data from the cache;
processing the first cache scan request; and
returning the successful completion of the first cache scan request and the second cache scan request upon the processing of the first cache scan request.

2. The method of claim 1 wherein the second extent of data is identical to the first extent of data.

3. The method of claim 1 wherein the second extent of data is within the first extent of data.

4. The method of claim 1 wherein the processing of the first cache scan request does not occur until both the first and the second point-in-time logical copy relationships are established.

5. The method of claim 1 further comprising:
establishing a third point-in-time logical copy relationship between the source and a third target relating to a third extent of data;
receiving a third cache scan request related to the third point-in-time logical copy relationship to remove the third extent of data from the cache;
queuing the second cache scan request and the third cache scan request in a wait queue.

6. The method of claim 5 further comprising returning the successful completion of each cache scan request in the wait queue upon the processing of the first cache scan request.

7. The method of claim 6 wherein the return of the successful completion of each cache scan request in the wait queue occurs sequentially.

8. The method of claim 5 further comprising indicating the presence of one of the second cache scan request and the third cache scan request in the wait queue with a wait queue flag.

9. A computer storage system comprising:
means for establishing a first point-in-time logical copy relationship between a source and a first target relating to a first extent of data;
means for establishing a second point-in-time logical copy relationship between the source and a second target relating to a second extent of data;
means for receiving a first cache scan request related to the first point-in-time logical copy relationship to remove the first extent of data from a cache;
means for receiving a second cache scan request related to the second point-in-time logical copy relationship to remove the second extent of data from the cache;
means for processing the first cache scan request; and
means for returning the successful completion of the first cache scan request and the second cache scan request upon the processing of the first cache scan request.

10. The computer storage system of claim 9 wherein the second extent of data is identical to the first extent of data.

11. The computer storage system of claim 9 wherein the second extent of data is within the first extent of data.

12. The computer storage system of claim 9 wherein the processing of the first cache scan request does not occur until both the first and the second point-in-time logical copy relationships are established.

13. The computer storage system of claim 9 further comprising:
means for establishing a third point-in-time logical copy relationship between the source and a third target relating to a third extent of data;
means for receiving a third cache scan request related to the third point-in-time logical copy relationship to remove the third extent of data from the cache;
means for queuing the second cache scan request and the third cache scan request in a wait queue.

14. The computer storage system of claim 13 further comprising means for returning the successful completion of each cache scan request in the wait queue upon the processing of the first cache scan request.

15. The computer storage system of claim 14 wherein the return of the successful completion of each cache scan request in the wait queue occurs sequentially.

16. The computer storage system of claim 13 further comprising means for indicating the presence of one of the second cache scan request and the third cache scan request in the wait queue with a wait queue flag.

17. An article of manufacture for use in programming a storage device to managing data, the article of manufacture comprising instructions for:
establishing a first point-in-time logical copy relationship between a source and a first target relating to a first extent of data;
establishing a second point-in-time logical copy relationship between the source and a second target relating to a second extent of data;
receiving a first cache scan request related to the first point-in-time logical copy relationship to remove the first extent of data from a cache;
receiving a second cache scan request related to the second point-in-time logical copy relationship to remove the second extent of data from the cache;
processing the first cache scan request; and
returning the successful completion of the first cache scan request and the second cache scan request upon the processing of the first cache scan request.

18. The article of manufacture of claim 17 wherein the second extent of data is identical to the first extent of data.

19. The article of manufacture of claim 17 wherein the second extent of data is within the first extent of data.

20. The article of manufacture of claim 17 wherein the processing of the first cache scan request does not occur until both the first and the second point-in-time logical copy relationships are established.

21. The article of manufacture of claim 17 further comprising instructions for:
establishing a third point-in-time logical copy relationship between the source and a third target relating to a third extent of data;
receiving a third cache scan request related to the third point-in-time logical copy relationship to remove the third extent of data from the cache;
queuing the second cache scan request and the third cache scan request in a wait queue.

22. The article of manufacture of claim 21 further comprising instructions for returning the successful completion of each cache scan request in the wait queue upon the processing of the first cache scan request.

23. The article of manufacture of claim 22 wherein the return of the successful completion of each cache scan request in the wait queue occurs sequentially.

24. The article of manufacture of claim 21 further comprising instructions for indicating the presence of one of the second cache scan request and the third cache scan request in the wait queue with a wait queue flag.

25. A method of deploying computing infrastructure, comprising integrating computer readable code into a computing system, wherein the code in combination with the computing system is capable of performing the following:
establishing a first point-in-time logical copy relationship between a source and a first target relating to a first extent of data;
establishing a second point-in-time logical copy relationship between the source and a second target relating to a second extent of data;
receiving a first cache scan request related to the first point-in-time logical copy relationship to remove the first extent of data from a cache;
receiving a second cache scan request related to the second point-in-time logical copy relationship to remove the second extent of data from the cache;
processing the first cache scan request; and
returning the successful completion of the first cache scan request and the second cache scan request upon the processing of the first cache scan request.

26. The method of deploying computing infrastructure of claim 25 wherein the second extent of data is identical to the first extent of data.

27. The method of deploying computing infrastructure of claim 25 wherein the second extent of data is within the first extent of data.

28. The method of deploying computing infrastructure of claim 25 wherein the processing of the first cache scan request does not occur until both the first and the second point-in-time logical copy relationships are established.

29. The method of deploying computing infrastructure of claim 25 wherein the code in combination with the computing system is capable of performing the following:
establishing a third point-in-time logical copy relationship between the source and a third target relating to a third extent of data;
receiving a third cache scan request related to the third point-in-time logical copy relationship to remove the third extent of data from the cache;
queuing the second cache scan request and the third cache scan request in a wait queue.

30. The method of deploying computing infrastructure of claim 29 wherein the code in combination with the computing system is capable of returning the successful completion of each cache scan request in the wait queue upon the processing of the first cache scan request.

31. The method of deploying computing infrastructure of claim 30 wherein the code in combination with the computing system is capable of causing the return of the successful completion of each cache scan request in the wait queue sequentially.

32. The method of deploying computing infrastructure of claim 29 wherein the code in combination with the computing system is capable of indicating the presence of one of the second cache scan request and the third cache scan request in the wait queue with a wait queue flag.
